(19) United States
(12) Patent Application Publication
(10) Pub. No.: US 2018/0058340 A1
(43) Pub. Date: Mar. 1, 2018

(54) SUPERCHARGED INTERNAL COMBUSTION ENGINE WITH COMPRESSOR, EXHAUST-GAS RECIRCULATION ARRANGEMENT AND FLAP

(71) Applicant: Ford Global Technologies, LLC, Dearborn, MI (US)

(72) Inventors: Andreas Kuske, Geulle (NL); Christian Winge Vigild, Aldenhoven (DE); Franz Arnd Sommerhoff, Aachen (DE); Joerg Kemmerling, Monschau (DE); Vanco Smiljanovski, Bedburg (DE); Helmut Matthias Kindl, Aachen (DE); Hanno Friederichs, Aachen (DE)

(21) Appl. No.: 15/684,795

(22) Filed: Aug. 23, 2017

(30) Foreign Application Priority Data
Aug. 24, 2016 (DE) 102016215865.1

(51) Int. Cl. F02D 9/10; F02D 41/00; F02D 41/26

(52) U.S. Cl. CPC F02D 9/10; F02D 41/005; F02M 26/02; F02D 41/26; F02D 41/0007

(57) ABSTRACT

Methods and systems are provided for an at least partially insulated throttle valve. In one example, a system may include a throttle valve having a first side configured to contact intake air flow and a second side configure to contact exhaust gas recirculate flow, where at least a portion of the second side comprises thermally insulating materials.

### CROSS REFERENCE TO RELATED APPLICATION

The present application claims priority to German Patent Application No. 102016215865.1, filed Aug. 24, 2016. The entire contents of the above-referenced application are hereby incorporated by reference in its entirety for all purposes.

### FIELD

The present description relates generally to an integrated valve for a motor vehicle comprising an internal combustion engine, and to a motor vehicle having integrated valve of this kind.

### BACKGROUND/SUMMARY

An internal combustion engine of the type mentioned in the introduction is used as a motor vehicle drive unit. Within the context of the present disclosure, the expression “internal combustion engine” encompasses diesel engines and Otto-cycle engines and also hybrid internal combustion engines, which utilize a hybrid combustion process, and hybrid drives which comprise not only the internal combustion engine but also an electric machine which can be connected in terms of drive to the internal combustion engine and which receives power from the internal combustion engine or which, as a switchable auxiliary drive, additionally outputs power.

In recent years, there has been a trend in development towards supercharged engines, wherein the economic significance of said engines for the automobile industry continues to steadily increase.

Supercharging is primarily a method for increasing performance in which the air required for the combustion process in the engine is compressed, as a result of which a greater air mass can be fed to each cylinder in each working cycle. In this way, the fuel mass and therefore the mean pressure can be increased.

Supercharging is a suitable means for increasing the power of an internal combustion engine while maintaining an unchanged swept volume, or for reducing the swept volume while maintaining the same power. In any case, supercharging leads to an increase in volumetric power output and a more expedient power-to-weight ratio. If the swept volume is reduced, it is thus possible to shift the load collective toward higher loads, at which the specific fuel consumption is lower. By means of supercharging in combination with a suitable transmission configuration, it is also possible to realize so-called downspeeding, with which it is likewise possible to achieve a lower specific fuel consumption.

Supercharging consequently assists in the constant efforts in the development of internal combustion engines to minimize fuel consumption, that is to say to improve the efficiency of the internal combustion engine.

For supercharging, use is often made of an exhaust-gas turbocharger, in which a compressor and a turbine are arranged on the same shaft. The hot exhaust-gas flow is fed to the turbine and expands in the turbine with a release of energy, as a result of which the shaft is set in rotation. The energy supplied by the exhaust-gas flow to the turbine and ultimately to the shaft is used for driving the compressor which is likewise arranged on the shaft. The compressor conveys and compresses the charge air fed to it, as a result of which supercharging of the cylinders is obtained. A charge-air cooler is advantageously provided in the intake system downstream of the compressor, by means of which charge-air cooler the compressed charge air is cooled before it enters the at least one cylinder. The cooler lowers the temperature and thereby increases the density of the charge air, such that the cooler also contributes to improved charging of the cylinders, that is to say to a greater air mass. Compression by cooling takes place.

The advantage of an exhaust-gas turbocharger in relation to a supercharger—which can be driven by means of an auxiliary drive—consists in that an exhaust-gas turbocharger utilizes the exhaust-gas energy of the hot exhaust gases, whereas a supercharger draws the energy required for driving it directly or indirectly from the internal combustion engine and thus adversely affects, that is to say reduces, the efficiency, at least for as long as the drive energy does not originate from an energy recovery source.

If the supercharger is not one that can be driven by means of an electric machine, that is to say electrically, a mechanical or kinematic connection for power transmission is generally required between the supercharger and the internal combustion engine, which also influences the packaging in the engine bay.

The advantage of a supercharger in relation to an exhaust-gas turbocharger consists in that the supercharger can generate, and make available, the required charge pressure at all times, specifically regardless of the operating state of the internal combustion engine. This applies in particular to a supercharger which can be driven electrically by means of an electric machine, and therefore independently of the rotational speed of the crankshaft.

In the prior art, it is specifically the case that difficulties are encountered in achieving an increase in power in all engine speed ranges by means of exhaust-gas turbocharging. A relatively severe torque drop is observed in the event of a certain engine speed being undershot. Said torque drop is understandable if one takes into consideration that the charge pressure ratio is dependent on the turbine pressure ratio or the turbine power. If the engine speed is reduced, this leads to a smaller exhaust-gas mass flow and therefore to a lower turbine pressure ratio or lower turbine power. Consequently, toward lower engine speeds, the charge pressure ratio likewise decreases. This equates to a torque drop.

The internal combustion engine to which the present disclosure relates has a compressor for supercharging purposes, wherein, in the context of the present disclosure, both a supercharger that can be driven by means of an auxiliary drive and a compressor of an exhaust-gas turbocharger can be subsumed under the expression “compressor”.

It is a further basic aim to reduce pollutant emissions. Supercharging can likewise be expedient in solving this problem. With targeted configuration of the supercharging, it is possible specifically to obtain advantages with regard to efficiency and with regard to exhaust-gas emissions. To adhere to future limit values for pollutant emissions, however, further measures are necessary in addition to the supercharging arrangement.

For example, exhaust-gas recirculation serves for reducing the untreated nitrogen oxide emissions. Here, the recirculation rate x_{EGR} is determined as x_{EGR}=m_{EGR}/(m_{EGR}+m_{fresh air}), where m_{EGR} denotes the mass of recirculated exhaust gas and m_{fresh air} denotes the supplied fresh air. Any oxygen or air recirculated via the exhaust-gas recirculation arrangement must be taken into consideration.

The internal combustion engine according to the disclosure which is supercharged by means of a compressor is also equipped with an exhaust-gas recirculation arrangement, wherein the recirculation line, which branches off from the exhaust-gas discharge system, opens into the intake system, so as to form a junction point, upstream of the compressor, as is generally the case in a low-pressure EGR arrangement, in which exhaust gas that has already passed through a turbine arranged in the exhaust-gas discharge system is recirculated to the inlet side. For this purpose, the low-pressure EGR arrangement comprises a recirculation line which branches off from the exhaust-gas discharge system downstream of the turbine and issues into the intake system preferably upstream of the compressor.

The internal combustion engine to which the present disclosure relates furthermore has a flap which is arranged in the intake system at the junction point. The flap may serve for the adjustment of the fresh-air quantity supplied via the intake system, and at the same time for the metering of the exhaust-gas quantity recirculated via the exhaust-gas recirculation arrangement, and is pivotable about an axis running transversely with respect to the fresh-air flow, in such a way that, in a first end position, the front side of the flap blocks the intake system, and at the same time the recirculation line is opened up, and in a second end position, the back side of the flap covers the recirculation line, and at the same time the intake system is opened up. In the above context, both “blocking” and “covering” do not imperatively also mean “closing”, or complete blocking and covering.

The axis, running transversely with respect to the fresh-air flow, about which the flap is pivotable need not be a physical axle. Rather, said axis may be a virtual axis, the position of which in relation to the rest of the intake system may furthermore exhibit a small amount of play, wherein the mounting or fastening is realized in some other way.

Problems may arise, when the exhaust-gas recirculation arrangement is active, if exhaust gas is introduced into the intake system upstream of the compressor. Specifically, condensate may form. In this context, several scenarios are of relevance.

Firstly, condensate can form if recirculated hot exhaust gas meets, and is mixed with, cool fresh air. The exhaust gas cools down, whereas the temperature of the fresh air is increased. The temperature of the mixture of fresh air and recirculated exhaust gas, that is to say the charge-air temperature, lies below the exhaust-gas temperature of the recirculated exhaust gas. During the course of the cooling of the exhaust gas, liquids previously contained in the exhaust gas still in gaseous form, in particular water, may condense if the dew point temperature of a component of the gaseous charge-air flow is undershot.

Condensate formation occurs in the free charge-air flow, wherein contaminants in the charge air often form the starting point for the formation of condensate droplets.

Secondly, condensate can form when recirculated hot exhaust gas and/or the charge air impinges on the internal wall of the intake system or on the internal wall of the compressor housing, as the wall temperature generally lies below the dew point temperature of the relevant gaseous components. In this context, the abovementioned flap, as an extended wall of the intake system, is of particular significance, because the flap is impinged on the front side with cool fresh air and on the back side with hot exhaust gas. The flap, which is cooled by the cool fresh air on the front side, has a likewise cool backside owing to heat conduction, as a result of which condensate forms abruptly as soon as hot exhaust gas strikes the flap or the back side of the flap.

The problem described above is intensified with increasing recirculation rate, because with the increase of the recirculated exhaust-gas flow rate, the fractions of the individual exhaust-gas components in the charge air, in particular the fraction of the water contained in the exhaust gas, inevitably increase. In the prior art, therefore, the exhaust-gas flow rate recirculated via the low-pressure EGR arrangement is commonly limited in order to prevent or reduce the occurrence of condensation. The required limitation of the low-pressure EGR on the one hand and the high exhaust-gas recirculation rates required for a considerable reduction in the nitrogen oxide emissions on the other hand lead to different aims in the dimensioning of the recirculated exhaust-gas flow rate. The legal demands for the reduction of the nitrogen oxide emissions highlight the high relevance of this problem in practice.

Condensate and condensate droplets are undesirable and lead to increased noise emissions in the intake system, and possibly to damage of the blades of the at least one compressor impeller. The latter effect is associated with a reduction in efficiency of the compressor.

The condensate formation occurs not only when the exhaust-gas recirculation arrangement is active but also when the exhaust gas recirculation arrangement is inactive, if the recirculation line is shut off by means of the flap and no hot exhaust gas is recirculated, wherein then, the condensate that precipitates on the back side of the flap collects on the flap and, upon opening of the flap, is abruptly introduced into the intake system as soon as hot exhaust gas is recirculated.

U.S. Pat. No. 8,297,922 B1 describes a cowl which is intended to protect the impeller of the compressor against damage and deposits. The cowl has two surfaces, wherein a first surface forms the front side of the cowl, which is exposed to the charge-air flow. A second surface, which is situated opposite the first surface and which forms the rear side of the cowl, faces toward the impeller. The rear side of the cowl is designed to fit accurately together with the front side of the impeller, such that no cavities are formed between the rear side of the installed cowl and the front side of the impeller. As is otherwise normally also the case with regard to the impeller of the compressor, the front side of the cowl is designed with regard to flow-related aspects, or the efficiency of the compressor.

The cowl described in U.S. Pat. No. 8,297,922 B1 involves a cumbersome and expensive concept. The cowl fully encases the impeller of the compressor at the front side, and must be manufactured in an accurately fitting manner, whereby high demands are placed on the manufacturing process. It would appear that the cowl described in U.S. Pat. No. 8,297,922 B 1 is designed as a wearing part which must be replaced during the course of maintenance work. This must be taken into consideration in particular with regard to the costs of the proposed protective measure.

Furthermore, the voluminous cowl has a corresponding weight, which is to be regarded as highly disadvantageous. Here, it must be taken into consideration that the cowl rotates with the rotating impeller of the compressor, and very high rotational speeds are realized, whereby correspondingly high forces act on the compressor shaft and in the bearing. Since the heavy cowl and furthermore also the rotating impeller of the compressor must be accelerated and decelerated, the response behavior of the compressor is not inconsiderably impaired.

Against this background, it is the object of the present disclosure to provide a supercharged internal combustion engine configured to cure disadvantages known from the reference is overcome. Specifically, the damage to the compressor resulting from condensate formation is counteracted.

One potential approach to at least partially solve the issues described above includes a supercharged internal combustion engine having an intake system for the supply of a charge-air flow, an exhaust-gas discharge system for the discharge of exhaust gas, at least one compressor arranged in the intake system, which compressor is equipped with at least one impeller which is mounted, in a housing, on a rotatable shaft, an exhaust-gas recirculation arrangement comprising a recirculation line which branches off from the exhaust-gas discharge system and which opens into the intake system, so as to form a junction point, upstream of the at least one impeller, and a flap which is delimited circumferentially by an edge and which is arranged in the intake system at the junction point and which is pivotable about an axis running transversely with respect to the fresh-air flow, in such a way that the flap, in a first end position, by way of a front side, blocks the intake system and opens up the recirculation line, and in a second end position, by way of a back side, covers the recirculation line and opens up the intake system, which internal combustion engine is distinguished by the fact that the flap is at least regionally equipped, at least on the exhaust-gas-side back side, with thermal insulation.

The flap of the internal combustion engine according to the disclosure is not, as in the prior art, manufactured in uniform fashion from one material and of uniform design. Rather, the flap according to the disclosure has thermal insulation at least on the back side, which is impinged on by the hot exhaust gas. The thermal insulation is intended to counteract the condensate formation on the back side of the flap, and to reduce or assist in preventing said condensate formation.

The back side of the flap is—at least regionally—equipped, that is to say coated, lined or the like, with thermal insulation. In the context of the present disclosure, thermal insulation is characterized by the fact that the thermal insulation exhibits low thermal conductivity, in particular lower thermal conductivity than a main material possibly used for the flap.

The disclosure relates to a supercharged internal combustion engine having an intake system for the supply of a charge-air flow, an exhaust-gas discharge system for the discharge of exhaust gas, at least one compressor arranged in the intake system, which compressor is equipped with at least one impeller which is mounted, in a housing, on a rotatable shaft, an exhaust-gas recirculation arrangement comprising a recirculation line which branches off from the exhaust-gas discharge system and which opens into the intake system, so as to form a junction point, upstream of the at least one impeller, and a flap which is delimited circumferentially by an edge and which is arranged in the intake system at the junction point and which is pivotable about an axis running transversely with respect to the fresh-air flow, in such a way that the flap, in a first end position, by way of a front side, blocks the intake system and opens up the recirculation line, and in a second end position, by way of a back side, covers the recirculation line and opens up the intake system.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1A schematically shows, in a side view, the compressor, arranged in the intake system, of a first embodiment of the internal combustion engine together with exhaust-gas recirculation arrangement, partially in section.

FIG. 1B schematically shows, in a perspective illustration, the flap of the embodiment illustrated in FIG. 1A, partially in section.

FIG. 1C schematically shows, in a perspective illustration, the flap of a second embodiment of the internal combustion engine.

FIG. 2 schematically depicts an example vehicle system including low-pressure EGR.

FIG. 3 shows an example position of the flap where intake gas and EGR flow to a compressor arranged downstream thereof.

### DETAILED DESCRIPTION

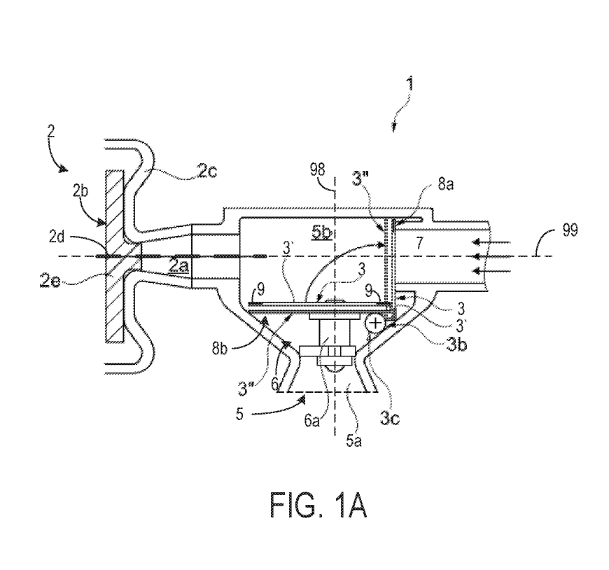

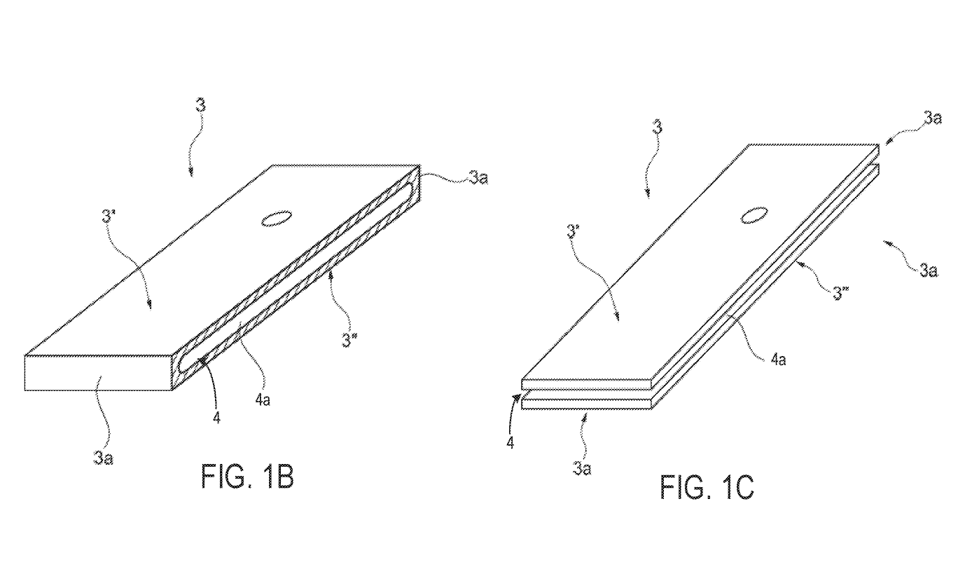

The following description relates to systems and methods for a flap valve. The flap valve may be a substantially planar valve configured to adjust an amount of gas flow through an intake passage to an engine. As shown in FIG. 1A, the flap valve may be adjusted to a first position, a second position, and one or more positions therebetween. In one example, the first position corresponds to a fully open position of the valve, where intake gas may freely flow to the engine. The second position corresponds to a fully closed position of the valve, where intake gas flow to the engine is substantially zero.

The flap valve further comprises an insulating portion coupled to an actuator of the flap valve such that the insulating portion may pivot and/or rotate with the flap valve. The insulating portion may be configured to thermally isolate the flap valve. As an example, the insulating portion may be arranged between the flap valve and an outlet of a low-pressure exhaust gas recirculation (LP-EGR). When LP-EGR flows into the intake passage, the LP-EGR may contact a surface of the insulating portion before flowing to the engine. In one example, the LP-EGR does not contact any surface of the flap valve. As such, a likelihood of condensate formation on the flap valve is reduced relative to a throttle valve not having an insulating portion. This may improve compressor function, which may include increased conditions where the compressor may be utilized without concern for condensate being swept into the compressor and a compressor longevity may increase. Additionally, combustion stability may increase due to condensate not being swept to the engine. Examples of the insulating portion are shown in FIGS. 1B and 1C.

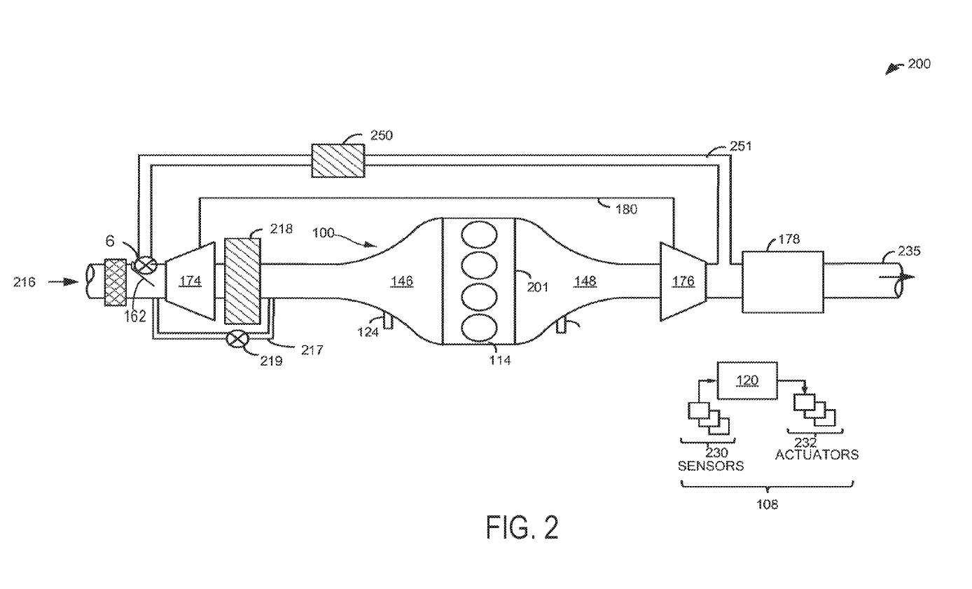

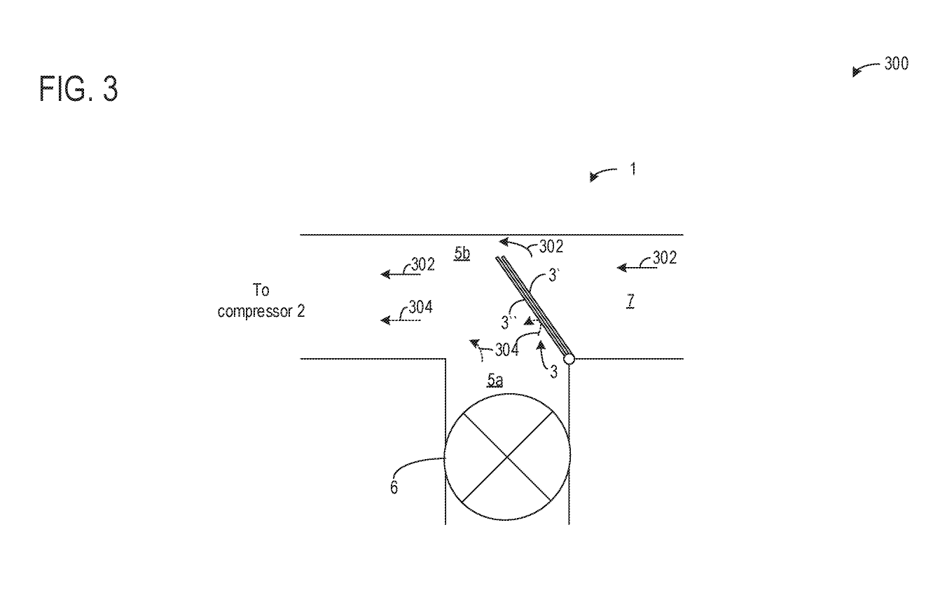

An engine schematic for an engine having at least one cylinder is shown in FIG. 2. Therein, the flap valve is shown at an intersection between a LP-EGR passage and an intake passage, similar to that of FIG. 1A. FIG. 3 shows a position of the flap where both intake air and EGR are flowing through a junction point to a compressor.

FIGS. 1A-1C show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

Note that FIG. 3 shows arrows indicating where there is space for gas to flow, and the solid lines of the device walls show where flow is blocked and communication is not possible due to the lack of fluidic communication created by the device walls spanning from one point to another. The walls create separation between regions, except for openings in the wall which allow for the described fluid communication.

According to the disclosure, the flap, which is cooled by the relatively cool fresh air at the front side, has a back side which is less cool owing to reduced or impeded heat conduction, whereby the condensate formation is counteracted.

According to the disclosure, the thermal insulation thus serves as a heat barrier, by means of which the heat permeability of the flap is reduced. By means of this measure, it is thought to advantageously reduce the amount of heat dissipated from the back side via the flap to the front side.

A flap according to the disclosure may also be formed by a conventional flap which has been enhanced or modified, in context of a reworking and/or retrofitting process, to form a flap according to the disclosure.

The risk of damage to the compressor owing to condensate droplets is reduced through the use of a flap designed according to the disclosure.

In this way, the object on which the disclosure is based is achieved, that is to say a supercharged internal combustion engine is provided by means of which the disadvantages known from the prior art are overcome and by means of which, in particular, the damage to the compressor as a result of condensate formation is counteracted.

In the context of the exhaust-gas recirculation, it is preferable for exhaust gas that has been subjected to exhaust-gas aftertreatment, in particular in a particle filter, to be conducted through the compressor. In this way, depositions in the compressor which change the geometry of the compressor, in particular the flow cross sections, and impair the efficiency of the compressor, can be prevented.

Further embodiments of the supercharged internal combustion engine will be discussed in conjunction with the subclaims.

Embodiments of the supercharged internal combustion engine in which the axis is arranged close to the edge, that is to say close to an edge section of the flap. In this embodiment, the flap is laterally mounted and pivotable similarly to a door, specifically at one of its edges. This distinguishes the flap according to the disclosure from centrally mounted shut-off elements or flaps, such as for example a butterfly valve.

Embodiments of the supercharged internal combustion engine in which the axis is arranged close to the wall, that is to say close to a wall section of the intake system. The intake system generally performs, with regard to the flap, the function of a frame, that is to say borders the flap. In this respect, an embodiment in which the axis is arranged close to an edge section of the flap is generally also an embodiment in which the axis is arranged close to a wall section of the intake system. The major advantage of both embodiments is that, in the second end position, the flap is positioned close to the wall, such that a completely free passage for the fresh air is realized.

Embodiments of the supercharged internal combustion engine in which more than 40% of the exhaust-gas-side back side is provided with thermal insulation.

Embodiments of the supercharged internal combustion engine in which more than 60% of the exhaust-gas-side back side is provided with thermal insulation.

Embodiments of the supercharged internal combustion engine in which more than 80% of the exhaust-gas-side back side is provided with thermal insulation.

In particular, embodiments of the supercharged internal combustion engine in which the entirety of the exhaust-gas-side back side is provided with thermal insulation.

The greater the area over which the back side is thermally insulated, the more effectively the thermal insulation can perform its function as a heat barrier, and the more effectively the condensate formation is counteracted.

Embodiments of the supercharged internal combustion engine in which the thermal insulation comprises plastic.

Embodiments of the supercharged internal combustion engine in which the thermal insulation comprises ceramic.

Embodiments of the supercharged internal combustion engine in which the thermal insulation comprises enamel.

Plastic, ceramic and enamel and the like are distinguished by low thermal conductivity, such that these materials are suitable for forming thermal insulation for preventing condensate formation on the back side of the flap.

Embodiments of the supercharged internal combustion engine in which the thermal insulation is formed at least inter alia by means of surface treatment. To form the thermal insulation, it is also possible for material, for example enamel or ceramic or the like, to be initially introduced and subsequently subjected to surface treatment. If appropriate, the thermal insulation is formed exclusively by surface treatment.

Embodiments of the supercharged internal combustion engine in which the thermal insulation is formed at least inter alia through the use of different materials for the flap, in such a way that the back side comprises a material with a thermal conductivity λ_{back}, and the front side comprises a material with a thermal conductivity λ_{front}, wherein the following applies: λ_{back}<λ_{front}.

Embodiments of the supercharged internal combustion engine in which the thermal insulation comprises at least one air cushion situated in a cavity. The air cushion serves as a heat barrier, whereby the thermal conductivity or the heat permeability of the flap is reduced.

In the present case, the cavity does not need to be a hermetically closed-off chamber. The air cushion may also be an air layer of a multi-layer flap which is formed so as to be open toward the edges. The cavity is however preferably a closed-off chamber from which the air cannot escape. Instead of air, use may also be made of some other gas or a liquid or the like, for example polystyrene or the like.

Embodiments of the supercharged internal combustion engine in which the flap is of modular construction. In particular if the thermal insulation or the flap comprises an air cushion or the like situated in a cavity, and/or is manufactured from multiple different materials, a modular construction of the flap is suitable.

Embodiments of the supercharged internal combustion engine in which at least one exhaust-gas turbocharger is provided which comprises a turbine arranged in the exhaust-gas discharge system and a compressor arranged in the intake system. With regard to the above embodiment, reference is made to the statements already made in conjunction with the exhaust-gas turbocharging arrangement, in particular the highlighted advantages.

In this context, embodiments of the supercharged internal combustion engine in which the at least one compressor is the compressor of the at least one exhaust-gas turbocharger.

Embodiments of the supercharged internal combustion engine in which the at least one compressor is a radial compressor. This embodiment permits dense packaging with regard to the supercharging arrangement. The compressor housing may be configured as a spiral or worm housing. In the case of an exhaust-gas turbocharger, the diversion of the charge-air flow in the compressor of the exhaust-gas turbocharger can advantageously be utilized for conducting the compressed charge air on the shortest path from the outlet side, on which the turbine of the exhaust-gas turbocharger is commonly arranged, to the inlet side.

In this connection, embodiments in which the turbine of the at least one exhaust-gas turbocharger is a radial turbine. This embodiment likewise permits dense packaging of the exhaust-gas turbocharger and thus of the supercharging arrangement as a whole.

By contrast to turbines, compressors are defined in terms of their exit flow. A radial compressor is thus a compressor whose flow exiting the rotor blades runs substantially radially. In the context of the present disclosure, “substantially radially” means that the speed component in the radial direction is greater than the axial speed component.

Embodiments of the supercharged internal combustion engine may include the at least one compressor is of axial type of construction. The flow exiting the impeller blades of an axial compressor runs substantially axially.

Embodiments of the supercharged internal combustion engine in which the at least one compressor has an inlet region which runs coaxially with respect to the shaft of the at least one impeller and which is designed such that the flow of charge air approaching the at least one impeller runs substantially axially.

In the case of an axial inflow to the compressor, a diversion or change in direction of the charge-air flow in the intake system upstream of the at least one impeller is often omitted, whereby unnecessary pressure losses in the charge-air flow owing to flow diversion are avoided, and the pressure of the charge air at the inlet into the compressor is increased. The absence of a change in direction also reduces the contact of the exhaust gas and/or charge air with the internal wall of the intake system and/or with the internal wall of the compressor housing, and thus reduces the heat transfer and the formation of condensate.

In the case of at least one exhaust-gas turbocharger being used, embodiments of the supercharged internal combustion engine in which the recirculation line branches off from the exhaust-gas discharge system downstream of the turbine of the at least one exhaust-gas turbocharger, in the manner of a low-pressure EGR arrangement.

In contrast to a high-pressure EGR arrangement, in which exhaust gas extracted from the exhaust-gas discharge system upstream of the turbine is introduced into the intake system, specifically preferably downstream of the compressor, in the case of a low-pressure EGR arrangement exhaust gas which has already flowed through the turbine is recirculated to the inlet side. For this purpose, the low-pressure EGR arrangement comprises a recirculation line which branches off from the exhaust-gas discharge system downstream of the turbine and which opens into the intake system upstream of the compressor.

The main advantage of the low-pressure EGR arrangement in relation to the high-pressure EGR arrangement is that the exhaust-gas flow introduced into the turbine during exhaust-gas recirculation is not reduced by the recirculated exhaust-gas flow rate. The entire exhaust-gas flow is always available at the turbine for generating an adequately high charge pressure.

The exhaust gas which is recirculated via the low-pressure EGR arrangement to the inlet side, and preferably cooled, is mixed with fresh air upstream of the compressor. The mixture of fresh air and recirculated exhaust gas produced in this way forms the charge air or combustion air which is supplied to the compressor and compressed.

Embodiments of the supercharged internal combustion engine in which a first shut-off element is arranged in the exhaust-gas discharge system downstream of the branching point of the recirculation line. The first shut-off element can be used for increasing the exhaust-gas pressure upstream of the shut-off element in the exhaust-gas discharge system, and can thus be utilized for increasing the pressure gradient between the exhaust-gas discharge system and the intake system. This offers advantages in particular in the case of high recirculation rates, which require a greater pressure gradient.

Embodiments of the supercharged internal combustion engine in which a second shut-off element is arranged in the intake system upstream of the junction point. The second shut-off element serves, at the inlet side, for reducing the pressure in the intake system, and is thus—like the first shut-off element—conducive to increasing the pressure gradient between the exhaust-gas discharge system and the intake system.

In this context, embodiments of the supercharged internal combustion engine in which the first and/or second shut-off element is a pivotable or rotatable flap.

To improve the torque characteristic of the supercharged internal combustion engine, it may be desired to provide two or more exhaust-gas turbochargers, for example multiple exhaust-gas turbochargers connected in series. By connecting two exhaust-gas turbochargers in series, of which one exhaust-gas turbocharger serves as a high-pressure stage and one exhaust-gas turbocharger serves as a low-pressure stage, the compressor characteristic map can advantageously be expanded, specifically both in the direction of smaller compressor flows and also in the direction of larger compressor flows.

In particular, with the exhaust-gas turbocharger which serves as a high-pressure stage, it is possible for the surge limit to be shifted in the direction of smaller compressor flows, as a result of which high charge pressure ratios can be obtained even with small compressor flows, which considerably improves the torque characteristic in the lower engine speed range. This is achieved by designing the high-pressure turbine for small exhaust-gas mass flows and by providing a bypass line by means of which, with increasing exhaust-gas mass flow, an increasing amount of exhaust gas is conducted past the high-pressure turbine.

Furthermore, the torque characteristic may be improved by means of multiple turbochargers arranged in parallel, that is to say by means of multiple turbines of relatively small turbine cross section arranged in parallel, wherein turbines are activated successively with increasing exhaust-gas flow rate.

A shift of the surge limit toward smaller charge-air flows is also possible in the case of turbochargers arranged in parallel, such that, in the presence of low charge-air flow rates, it is possible to provide charge pressures high enough to thereby ensure a satisfactory torque characteristic of the internal combustion engine at low engine speeds.

Furthermore, the response behavior of an internal combustion engine supercharged in this way is considerably improved in relation to a similar internal combustion engine with a single exhaust-gas turbocharger, because the relatively small turbines are less inert, and the rotor of a smaller-dimensioned turbine and of a smaller-dimensioned compressor can be accelerated more rapidly.

Embodiments of the supercharged internal combustion engine may be desired in which the recirculation line is equipped with a valve which comprises a valve body which is connected, and thereby mechanically coupled, to the flap, a pivoting of the flap causing an adjustment of the valve in space. The flap can consequently serve as an actuating device for the valve.

All variants of the above embodiments have in common the fact that the flap serves only for the setting of the air flow rate supplied via the intake system, and not for the metering of the recirculated exhaust-gas flow rate. The latter is effected by way of the valve, which is fitted in the recirculation line and serves as an EGR valve.

Embodiments of the supercharged internal combustion engine in which the junction point is formed and arranged in the vicinity of, at a distance Δ from, the at least one impeller. An arrangement of the junction point close to the compressor shortens the path for the hot recirculated exhaust gas from the point at which it is introduced into the intake system to the at least one impeller, such that the time available for the formation of condensate droplets in the free charge-air flow is reduced. A formation of condensate droplets is thus counteracted in this way.

Furthermore, a swirl introduced into the flow using the flap remains effective, that is to say is still pronounced, at the point at which the charge air enters the impeller. Specifically, embodiments in which the flap is not planar and has at least one deformation, as an unevenness, at least on the front side. The deformation of the flap gives rise to expedient flow effects. A substantially axial charge-air flow or fresh-air flow can have a speed component transverse with respect to the shaft of the compressor, that is to say a swirl, forcibly imparted to it by means of the flap. In this way, the surge limit of the compressor can be shifted toward smaller charge-air flows, whereby relatively high charge-pressure ratios are achieved even in the case of small charge-air flows.

In this connection, embodiments in which, for the distance Δ, the following applies: Δ≦2.0D_{V} or Δ≦1.5D_{V}, where D_{V} denotes the diameter of the at least one impeller. Embodiments are advantageous in which, for the distance Δ, the following applies: Δ≦1.0D_{V}, preferably Δ≦0.75D_{V}.

FIG. 1A schematically shows, in a side view, the compressor 2, arranged in the intake system 1, of a first embodiment of the internal combustion engine together with exhaust-gas recirculation arrangement 5, partially in section.

For the supply of the charge air to the cylinders, the internal combustion engine has an intake system 1, and for the supercharging of the cylinders, an exhaust-gas turbocharger is provided which comprises a turbine (shown in FIG. 2) arranged in the exhaust-gas discharge system and a compressor 2 arranged in the intake system 1. The compressor 2 is a radial compressor 2b, in the housing 2c of which an impeller 2e mounted on a rotatable shaft 2d rotates. The shaft 2d of the impeller 2e lies in the plane of the drawing of FIG. 1A, and runs horizontally. Said another way, the shaft 2d is parallel to a central axis 99 of the intake system 1, the central axis 99 and the shaft 2d being parallel to a direction of incoming intake gas flow (shown by arrows pointing from right to left sides of the figure). The shaft 2d is indicated by a dashed line thicker (e.g., bolder) than a dashed line of the central axis 99 for illustrative purposes.

The compressor 2 of the exhaust-gas turbocharger has an inlet region 2a which runs, and is formed, coaxially with respect to the shaft 2d of the compressor 2, such that the section of the intake system 1 upstream of the compressor 2 does not exhibit any changes in direction, and the flow of charge air approaching the compressor 2 of the exhaust-gas turbocharger, or the impeller 2e thereof, runs substantially axially. Said another way, the direction of incoming intake air flow is unchanged as it flows from an intake passage 7, through the inlet region 2a, and into the impeller 2e.

The internal combustion engine is furthermore equipped with an exhaust-gas recirculation arrangement 5 which comprises a recirculation line 5a which branches off from the exhaust-gas discharge system downstream of the turbine and which opens into the intake system 1, so as to form a junction point 5b, upstream of the compressor 2 and the compressor impeller 2e. In the present case, the junction point 5b is arranged close to, at a small distance from, the compressor 2. In one example, the distance is equal to a distance Δ, where Δ≦2.0D_{V} or Δ≦1.5D_{V}, where D_{V} denotes the diameter of the at least one impeller. Embodiments in which, for the distance Δ, the following applies: Δ≦1.0D_{V}, preferably Δ≦0.75D_{V}.

An EGR valve 6 which is arranged at the junction point 5b serves for the adjustment of the recirculated exhaust-gas flow rate. The EGR valve 6 comprises a valve body 6a which covers the recirculation line 5a and which is connected to a pivotable flap 3 and thereby mechanically coupled to the flap 3, a pivoting of the flap 3 causing an adjustment of the valve body 6a, that is to say a movement of the valve body 6a, in space. The flap 3 consequently serves as an actuating device for the valve 6.

The flap 3 which is arranged in the intake system 1 and likewise at the junction point 5b is circumferentially delimited by an edge, wherein the mounting 3c of the flap 3 is positioned in the intake system 1. The axis 3b, which runs transversely with respect to the fresh-air flow and about which the flap 3 is pivotable, is perpendicular to the plane of the drawing. In the present case, said axis 3b is arranged close to an edge section of the flap 3 and close to a wall section of the intake system 1, such that the flap 3 is laterally mounted, similarly to a door.

Said another way, the flap 3 is arranged in the intake system 1 at the junction point 5b upstream of the compressor 2. The flap 3 may function similarly to a throttle valve, as known by those skilled in the art. The flap 3 may be coupled to a mounting 3c arranged on a portion of a wall of the intake system 1 between the intake passage 7 and the recirculation line 5a. The mounting 5c may comprise an actuator configured to pivot the flap 3 about an axis perpendicular to both the central axis 99 and the vertical axis 98, where the vertical axis 98 runs through a center of the recirculation line 5a and is perpendicular to the central axis 99.

FIG. 1A shows the flap 3 in two different pivoting positions. In a first end position 8a (shown by the flap 3 illustrated in dashed lines), in which the flap 3 is perpendicular to the virtual elongation of the compressor shaft 2d and the central axis 99, the flap 3, by means of its front side 3′, blocks the intake system 1. In a second end position 8b, in which the flap 3 extends parallel to the virtual elongation of the compressor shaft 2d, the back side 3″ of the flap 3 covers the recirculation line 5a of the exhaust-gas recirculation arrangement 5, whereas the intake system 1 is opened up. In one example, the exhaust-gas recirculation arrangement 5 is a low-pressure exhaust gas recirculation (LP-EGR) arrangement. The valve 6 itself is illustrated only for the flap 3 situated in the second end position.

A pivoting movement of the flap 3 is linked to an adjustment of the valve body 6a of the EGR valve 6, wherein the flap 3 serves only for the setting of the air flow rate supplied via the intake system 1, and not for the metering of the recirculated exhaust-gas flow rate. The latter is performed by the EGR valve 6.

In some embodiments, mechanically coupling the flap 3 to the valve body 6a includes actuating the valve body 6a to an at least partially open position when the flap 3 moves outside of the second end position 8b toward the first end position 8a. As such, the valve body 6a may now be actuated to a position where exhaust gas recirculate may flow therethrough. As such, exhaust gas recirculate may flow to the junction 5b when an actuator of the EGR valve 6 moves a portion of the EGR valve 6 to an at least partially open position and when the flap 3 is outside of the second end position 8b such that the valve body 6a is also configured to flow exhaust gas recirculate to the junction 5b.

Additionally or alternatively, the flap 3 may be mechanically coupled to the valve body 6a such that it depresses the valve body 6a, thereby allowing the EGR valve 6 to leak at least some exhaust gas recirculate toward the flap 3. In this way, small amounts of exhaust gas recirculate may flow into the junction 5b when the flap 3 is in the second end position 8b. In one example, a small amount of exhaust gas recirculate is less than a threshold amount, where the threshold amount is based on a lowest amount of exhaust gas recirculate demanded for intake air dilution. In this example, the EGR valve 6 may be a poppet valve, with the valve body 6a being configured to actuate when the flap 3 is in the second end position 8b.

In this way, the flap 3 comprises a front side 3′ and a back 3″ side, where the front 3′ and back 3″ sides are parallel to one another throughout a range of motion of the flap 3. In one example, the front 3′ and back 3″ sides follow each other through a motion of the flap 3 such that the front 3′ and back 3″ sides maintain a constant distance and orientation relative to one another.

The front side 3′ may be single plate comprising steel, iron, or the like. The front side 3′ may be circular or some other shape similar to a shape of the intake passage 7. The backside 3″ may be ceramic, plastic, or similar material comprising a thermal conductivity lower than a thermal conductivity than the front side 3′. In one example, the backside 3″ is thermally insulating and may herein be interchangeably referred to as the insulating portion 3″. The backside 3″, additionally or alternatively, may further comprise an air gap or some other insulating arrangement therein. Additionally or alternatively, the flap 3 may be a single, continuous piece, having an air gap or other insulating arrangement between the front side 3′ and the backside 3″. In this example, a material of the backside 3″ may still be less thermally conductive than a material of the front side 3′. In the orientation depicted in FIG. 1A, the backside 3″ may mitigate and/or prevent EGR from contacting the front side 3′. As such, a temperature of the front side 3′ may be substantially similar to a temperature of incoming intake air flow since EGR may not warm it up. By doing this, water vapor in the EGR may not condensate onto the front side 3′, thereby decreasing an amount of condensate forming in the intake system 1 upstream of the compressor 2. Due to the arrangement of the front side 3′ and the backside 3″, EGR may not contact the front side 3′ and intake air may not contact the backside 3″. This will be described in greater detail below.

It will be appreciated that the front side 3′ and the backside 3″ may be reversed without departing from the scope of the present disclosure. For example, the front side 3′ may be thermally insulating. As such, the backside 3″ may comprise a higher thermal conductivity than the front side 3′.

The flap 3 is adjustable from the first position 8a to the second position 8b and vice-versa via directions from a controller to the actuator in the mounting 3c based on one or more engine operating parameters. The first position 8a includes orienting the front side 3′ and the backside 3″ in a direction substantially parallel to the vertical axis 98. In the first position 8a, the front side 3′ may be pressed against a downstream extreme end of the intake passage 7, wherein the front side 3′ is substantially blocking incoming intake air flow from flowing to the compressor 2. In this way, the first position 8a may also be referred to as a fully closed position. In one example, the seal between the front side 3′ and the intake passage 7 is not hermetic and a relatively small amount of incoming intake air may flow from the intake passage 7 to the compressor (e.g., 5% or less of a maximum amount of allowable intake air flow when the flap 3 is in a fully open position). In another example, the seal between the front side 3′ and the intake passage 7 is hermetic when the flap 3 is in the first position 8a and substantially zero intake air flows to the compressor 2.

The second position 8b includes orienting the front side 3′ and the backside 3″ in a direction substantially parallel to the central axis 99, the compressor shaft 2d, and the direction of incoming intake air flow. In the second position 8b, the backside 3″ is pressed against a wall of the junction point 5b upstream of the compressor 2 and downstream of the mounting 3b. As shown, the backside 3″ substantially blocks the recirculation line 5a from flowing EGR to the junction point 5b and the compressor 2. As such, when the flap 3 is in the second position 8b, a maximum amount of intake air flow may flow from the intake passage 7, through the junction point 5b, and into the compressor 2 with little to no EGR flow flowing therewith. Herein, the second position 8b may be interchangeably referred to as the fully open position, where in the fully open position, intake air flows freely to the compressor 2 with little to no obstructions and where EGR does not flow to the compressor 2. When in the fully open position, only EGR may contact the backside 3″, while the front side 3′ is in contact with only incoming intake air flow.

The flap 3 may be actuated between the first position 8a and the second position 8b such that the flap 3 may be held at one of a variety of positions between the first 8a and second 8b positions. These positions may be referred to as more open and more closed positions, where a more open position is closer to the fully open position than it is to the fully closed position. Thus, the more closed position is closed to the fully closed position than it is to the fully open position. As such, a more open position may allow more intake air to flow to the compressor 2 than a more closed position.

FIG. 1A further shows an embodiment of the flap 3 where the flap 3 optionally comprises a sealing element 9 on its front side 3′ away from a thermal insulation 4. The sealing element may be circular and arranged along an outer circumferential edge of the front side 3′. In one example, the sealing element 9 is arranged such that it is spaced away from a geometric center of the flap 3. In this way, the sealing element 9 is evenly spaced away from the central axis 99 in the first position 8a and evenly spaced away from the vertical axis 98 in the second position 8b. The sealing element 9 may be flush with a surface of the front side 3′ such that it does not obstruct intake air flow through the junction 5b. Additionally or alternatively, the sealing element 9 may not be flush such that it protrudes from the front side 3′. A cross-section of the sealing element may be U-shaped in such an example where the sealing element 9 protrudes from the front side 3′. Additionally or alternatively, the cross-section may be triangular. The cross-section may be in reference to a cross-section taken of the sealing element 9 parallel to the central axis 99 when the flap 3 is in the first position 8a.

The sealing element 9 may comprise of an elastomeric material. A stop of the intake passage 7 may contact the sealing element 9 when the flap 3 is in the first position 8a. This may improve a seal formed between the flap 3 and the intake passage 7. As such, less air may leak from the intake passage 7 to the junction 5b when the flap 3 comprises sealing element 9 compared to a flap not having the sealing element 9.

FIG. 1B schematically shows, in a perspective illustration, the flap 3 of the embodiment illustrated in FIG. 1A, partially in section. It is sought merely to explain the additional features in relation to FIG. 1A, for which reason reference is made otherwise to FIG. 1A. The same reference signs have been used for the same parts and components.

As emerges from FIG. 1B, the flap 3 is equipped, on the exhaust-gas-side back side 3″, with thermal insulation 4. In one example, the thermal insulation 4 may be an insulating plate spaced away from the flap 3 and physically coupled to the mounting 3c. In the present case, the thermal insulation 4 is formed by an air cushion 4a in a cavity. The thermal conductivity or the heat permeability of the flap 3 is greatly reduced by means of the air cushion 4a. The air cushion 4a is intended to advantageously reduce the amount of heat conducted from the back side 3″ via the flap 3 to the front side 3′. In FIG. 1B, the cavity is a closed-off chamber from which the air cannot escape. In the example of FIG. 1B, a temperature of the front side 3′ is substantially similar to a temperature of intake air flow and a temperature of the backside 3″ is substantially similar to a temperature of EGR, where the temperatures of the front side 3′ and the backside 3″ are independent of one another due to the thermal insulation 4 (e.g., the air cushion 4a).

FIG. 1C schematically shows, in a perspective illustration, the flap 3 of a second embodiment of the internal combustion engine. It is sought merely to explain the differences in relation to FIG. 1B, for which reason reference is made otherwise to FIG. 1B. The same reference signs have been used for the same parts and components.

In the present case, the chamber for the air cushion 4a is formed so as to be open toward the edges 3a of the flap 3. In effect, the air cushion 4a forms a centrally arranged air layer in a multi-layer flap 3. Thus, the air cushion 4a is not a sealed chamber, but a space and/or gap arranged between the front side 3′ and the backside 3″. In this way, the flap 3 may comprise two plates opposite one another and a space separating the plates for air to flow. In one example, the backside 3″ comprises a length greater than or equal to a length of the front side 3′. As such, the backside 3″ may completely block EGR from contacting the front side 3′.

At any rate, both the embodiments of FIGS. 1B and 1C achieve similar thermal insulation of at least one side of the flap 3. A first side of the flap 3 may be in contact with only intake air and a second side of the flap 3 may only be in contact with EGR flow. At least one of the first and second sides of the flap 3 may comprise a relatively thermally nonconductive material such that the second side contacting EGR does not heat the first side contacting the first side. As such, temperatures of the first and second sides are independent of one another.

FIG. 2 shows a schematic diagram of a vehicle system 200 with a multi-cylinder engine system 100 coupled in a motor vehicle in accordance with the present disclosure. As depicted in FIG. 2, internal combustion engine 100 includes a controller 120 which receives inputs from a plurality of sensors 230 and sends outputs from a plurality of actuators 232. Engine 100 further includes cylinders 114 coupled to intake passage 146 and exhaust passage 148. Intake passage 146 may include throttle 162. In one example, the intake passage 146 and the throttle 162 may be used similarly to intake passage 7 and flap 3 of FIG. 1A. Exhaust passage 148 may include emissions control device 178. Engine 100 is shown as a boosted engine, coupled to a turbocharger with compressor 174 connected to turbine 176 via shaft 180. In one example, the compressor and turbine may be coupled within a twin scroll turbocharger. In another example, the turbocharger may be a variable geometry turbocharger, where turbine geometry is actively varied as a function of engine speed and other operating conditions. The compressor 174 and shaft 180 may be used similarly to compressor 2 and rotatable shaft 2d of FIG. 1A.

The compressor 174 is coupled to charge air cooler (CAC) 218. The CAC 218 may be an air-to-air or air-to-water heat exchanger, for example. From the compressor 174, the hot compressed air charge enters the inlet of the CAC 218, cools as it travels through the CAC, and then exits to the intake manifold 146. Ambient airflow 216 from outside the vehicle may enter engine 10 and pass across the CAC 218 to aid in cooling the charge air. A compressor bypass line 217 with a bypass valve 219 may be positioned between the inlet of the compressor 2 and outlet of the CAC 218. The controller 120 may receive input from compressor inlet sensors such as compressor inlet air temperature, inlet air pressure, etc., and may adjust an amount of boosted aircharge recirculated across the compressor for boost control.

Intake passage 146 is coupled to a series of cylinders 114 through a series of intake valves. The cylinders 114 are further coupled to exhaust passage 148 via a series of exhaust valves. In the depicted example, a single intake passage 146 and exhaust passage 148 are shown. In another example, the cylinders may include a plurality of intake passages and exhaust passages to form an intake manifold and exhaust manifold respectively. For example, configurations having a plurality of exhaust passages may enable effluent from different combustion chambers to be directed to different locations in the engine system.

The exhaust from exhaust passage 148 is directed to turbine 176 to drive the turbine. When a reduced turbine torque is desired, some exhaust may be directed through a wastegate (not shown) to bypass the turbine. The combined flow from the turbine and wastegate flows through the emission control device 178. One or more aftertreatment devices may be configured to catalytically treat the exhaust flow, thereby reducing an amount of one or more substances in the exhaust. The treated exhaust may be released into the atmosphere via exhaust conduit 235.

An LP-EGR line 251 is arranged to capture a portion of exhaust gas between the turbine 176 and the emission control device 178. The LP EGR line 251 may be used substantially similarly to the recirculation line 5 of FIG. 1A. A cooler 250 is along in the LP-EGR line 251 and configured to lower a temperature of LP-EGR in a manner similar to that described for the CAC 218. In some examples, the LP-EGR line 251 may further comprise a cooler bypass configured to direction LP-EGR around the cooler 250 when cooling is not desired. EGR valve 6 may adjust an amount of LP-EGR flowing to the intake passage 146. In one example, LP-EGR may only flow to the intake passage 146 when the EGR valve 6 is at least partially open and the throttle 162 is outside of a fully open position (e.g., the second position 8b of FIG. 1A).

Turning now to FIG. 3, it shows an embodiment 300 of an example gas flows from the intake passage 7 and the recirculation line 5a simultaneously. Arrows 302 indicate intake air flow and arrow 304 indicate LP-EGR flow. In the present embodiment 300, the flap 3 is in a more closed position and the EGR valve 6 is in an at least partially open position such that at least some LP-EGR may flow from the recirculation line 5a, through the junction point 5b, and to the compressor 2.

Intake air 302 flows toward the front side 3′ of the flap 3, where the intake air 302 may collide with the front side 3′ before flowing through a gap between the flap 3 and a first wall of the junction point 5b. In one example where the front side 3′ and the backside 3″ are substantially identical in length and size, the intake air 302 does not contact the backside 3″ as it flows through the gap, passed the flap 3, and toward the compressor 2. Additionally or alternatively, in another example where the backside 3″ is longer than the front side 3′, the intake air 302 may contact a portion of the backside 3″ extending beyond a profile of the front side 3′, where a length of the portion is equal to a difference of the lengths of the backside 3″ and the front side 3′.

LP-EGR 304 flows from the recirculation line 5a toward the backside 3″ of the flap 3, where the LP-EGR 304 may collide with the backside 3″ before flowing through a gap formed between the flap 3 and a second wall of the junction point 5b. As shown, the first wall and second wall are arranged on opposite side of the junction point 5b. The backside 3″ may be at least equal in length to the front side 3′ such that LP-EGR only contacts the backside 3″ and does not come into contact with the front side 3′. As such, the LP-EGR may only touch the backside 3″ and surfaces of the junction point 5b before it flows to the compressor 2. Intake gas 302 and LP-EGR 304 may mix in a portion of the intake system 1 downstream of the flap 3 before reaching the compressor 2. Due to the arrangement of the flap 3 described above, an amount of condensate included in the intake gas 302 and LP-EGR 304 flow to the compressor 2 may be less than an amount of condensate in an intake system comprising a throttle not having an insulated portion. In this way, a likelihood of water droplets due to condensate colliding with blades of the compressor is reduced, resulting in a lower likelihood of degradation.

Additionally, an engine power output and/or efficiency may increase due to increased combustion stability and an increased operating range in which the compressor may be used resulting from the decrease in water being swept to the engine.

In this way, a combination valve comprising a flap with an insulating element may be used to reduce condensate formation in an intake system. The insulating element may be positioned between a first side and a second side of the flap. The technical effect of arranging the insulating between the first and second sides of the flap is to maintain separate thermal environments of the first and second sides such that condensate may not form on both sides. The first side may face an intake air flow and the second side may face an EGR flow. By doing this, the second side may shield the first side from the higher EGR temperatures relative to the lower intake air temperatures. In this way, EGR does not contact the first side and does not come into contact with portions of the flap onto which water from the EGR may condense.

An embodiment of a supercharged internal combustion engine comprises an intake system for the supply of a charge-air flow, an exhaust-gas discharge system for the discharge of exhaust gas, at least one compressor arranged in the intake system, wherein the compressor is equipped with at least one impeller mounted in a housing on a rotatable shaft, an exhaust-gas recirculation arrangement comprising a recirculation line which branches off from the exhaust-gas discharge system and which opens into the intake system, so as to form a junction point upstream of the at least one impeller, and a flap which is delimited circumferentially by an edge and which is arranged in the intake system at the junction point and which is pivotable about an axis running transversely with respect to the fresh-air flow, in such a way that the flap, in a first end position, by way of a front side, blocks the intake system and opens up the recirculation line, and in a second end position, by way of a back side, covers the recirculation line and opens up the intake system, wherein the flap is equipped at least on the exhaust-gas-side back side with thermal insulation. A first example of the supercharged internal combustion engine further includes where axis is arranged close to an edge section of the flap, where the edge section of the flap is arranged close to a wall section of the intake system between the recirculation line and the intake system. A second example of the supercharged internal combustion engine, optionally including the first example, further includes where the backside is thermally insulated between 60-100%. A third example of the supercharged internal combustion engine, optionally including the first and/or second examples further includes where the thermal insulation comprises one or more of plastic and ceramic. A fourth example of the supercharged internal combustion engine, optionally including one or more of the first through third examples, further includes where the thermal insulation is a surface treatment. A fifth example of the supercharged internal combustion engine, optionally including one or more of the first through fourth examples the front side and the backside comprise different materials, wherein the back side comprises a material with a thermal conductivity λ_{back}, and the front side comprises a material with a thermal conductivity λ_{front}, wherein the following applies: λ_{back}<λ_{front}. A sixth example of the supercharged internal combustion engine, optionally including one or more of the first through fifth examples the thermal insulation comprises an air cushion in a hermetically sealed cavity. A seventh example of the supercharged internal combustion engine, optionally including one or more of the first through sixth examples the recirculation line is a low-pressure exhaust gas recirculation line. An eighth example of the supercharged internal combustion engine, optionally including one or more of the first through seventh examples the recirculation line is equipped with a valve which comprises a valve body which is connected, and thereby mechanically coupled, to the flap, wherein a pivoting of the flap causes an adjustment of the valve.

An embodiment of a system comprising a throttle arranged at a junction between an intake passage and an exhaust gas recirculation passage, the throttle comprising a first side and a second side, where the first side comes into contact with only gas from the intake passage and the second side comes into contact with only gas from the exhaust gas recirculation passage, and where at least a portion of the second side is thermally insulated. A first example of the system further includes where the first side and the second side are thermally independent of one another, and where a temperature of the first side is similar to a temperature of gas from the intake passage and where a temperature of the second side is similar to a temperature of gas from the exhaust gas recirculation passage. A second example of the system, optionally including the first example, further includes where the first side and the second side are impervious to gas flow. A third example of the system, optionally including the first and/or second examples, further includes where the first side and the second side are parallel. A fourth example of the system, optionally including one or more of the first through third examples, further includes where the second side comprises a length greater than or equal to a length of the first side. A fifth example of the system, optionally including one or more of the first through fourth examples, further includes where the exhaust gas recirculation line is a low-pressure exhaust gas recirculation line and where low-pressure exhaust gas recirculate from the exhaust gas recirculation line contacts only the second side of the throttle. A sixth example of the system, optionally including one or more of the first through fifth examples, further includes where the throttle is pivotally arranged at the junction, the throttle configured to move to a first position, a second position, or a plurality of positions therebetween, where the first position includes covering an end of the intake passage with the first side and where the second position includes covering an end of the exhaust gas recirculation line with the second side. A seventh example of the system, optionally including one or more of the first through sixth examples, further includes where the first side and second side are perpendicular to a central axis of the intake passage in the first position, and where the first side and second side are perpendicular to a vertical axis of the exhaust gas recirculation line in the second position, wherein the central axis and vertical axis are perpendicular to one another.

An embodiment of an engine intake system comprises a throttle valve having a front side and a backside, where at least the backside includes an insulating element thermally isolating the backside from the front side, the throttle valve being arranged at a junction between an intake passage and a low-pressure exhaust gas recirculation passage between a compressor and the intake passage, a mounting arranged along a wall of the junction between the intake passage and the low-pressure exhaust gas recirculation passage, wherein the mounting comprises an actuator configured to pivot the throttle valve between a first position, a second position, and a plurality of positions therebetween, and a controller with computer-readable instructions that when executed enable the controller to pivot the throttle valve toward the first position when less intake air is desired and pivot the throttle valve toward the second position when more intake air is desired. A first example of the engine intake system further includes where the first position includes blocking intake air flow from the intake passage to the compressor via the front side, and where the second position includes blocking low-pressure exhaust gas recirculate flow via the backside. A second example of the engine intake system, optionally including the first example, further includes where the front side does not thermally communicate with the backside.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A supercharged internal combustion engine comprising:
an intake system for the supply of a charge-air flow, an exhaust-gas discharge system for the discharge of exhaust gas, at least one compressor arranged in the intake system, wherein the compressor is equipped with at least one impeller mounted in a housing on a rotatable shaft;
an exhaust-gas recirculation arrangement comprising a recirculation line which branches off from the exhaust-gas discharge system and which opens into the intake system, so as to form a junction point upstream of the at least one impeller; and
a flap which is delimited circumferentially by an edge and which is arranged in the intake system at the junction point and which is pivotable about an axis running transversely with respect to the fresh-air flow, in such a way that the flap, in a first end position, by way of a front side, blocks the intake system and opens up the recirculation line, and in a second end position, by way of a back side, covers the recirculation line and opens up the intake system, wherein the flap is equipped at least on the exhaust-gas-side back side with thermal insulation.

2. The supercharged internal combustion engine as claimed in claim 1, wherein the axis is arranged close to an edge section of the flap, where the edge section of the flap is arranged close to a wall section of the intake system between the recirculation line and the intake system.

3. The supercharged internal combustion engine of claim 1, wherein the backside is thermally insulated between 60-100%.

4. The supercharged internal combustion engine of claim 1, wherein the thermal insulation comprises one or more of plastic and ceramic.

5. The supercharged internal combustion engine of claim 1, wherein the thermal insulation is a surface treatment.

6. The supercharged internal combustion engine of claim 1, wherein the front side and the backside comprise different materials, wherein the back side comprises a material with a thermal conductivity λ_{back}, and the front side comprises a material with a thermal conductivity λ_{front}, wherein the following applies: λ_{back}<λ_{front}.

7. The supercharged internal combustion engine of claim 1, wherein the thermal insulation comprises an air cushion in a hermetically sealed cavity.

8. The supercharged internal combustion engine of claim 1, wherein the recirculation line is a low-pressure exhaust gas recirculation line.

9. The supercharged internal combustion engine of claim 1, wherein the recirculation line is equipped with a valve which comprises a valve body which is connected, and thereby mechanically coupled, to the flap, wherein a pivoting of the flap causes an adjustment of the valve.

10. A system comprising:
a throttle arranged at a junction between an intake passage and an exhaust gas recirculation passage, the throttle comprising a first side and a second side, where the first side comes into contact with only gas from the intake passage and the second side comes into contact with only gas from the exhaust gas recirculation passage, and where at least a portion of the second side is thermally insulated.

11. The system of claim 10, wherein the first side and the second side are thermally independent of one another, and where a temperature of the first side is similar to a temperature of gas from the intake passage and where a temperature of the second side is similar to a temperature of gas from the exhaust gas recirculation passage.

12. The system of claim 10, wherein the first side and the second side are impervious to gas flow.

13. The system of claim 10, wherein the first side and the second side are parallel.

14. The system of claim 10, wherein the second side comprises a length greater than or equal to a length of the first side.

15. The system of claim 10, wherein the exhaust gas recirculation line is a low-pressure exhaust gas recirculation line and where low-pressure exhaust gas recirculate from the exhaust gas recirculation line contacts only the second side of the throttle.

16. The system of claim 10, wherein the throttle is pivotally arranged at the junction, the throttle configured to move to a first position, a second position, or a plurality of positions therebetween, where the first position includes covering an end of the intake passage with the first side and where the second position includes covering an end of the exhaust gas recirculation line with the second side.

17. The system of claim 16, wherein the first side and second side are perpendicular to a central axis of the intake passage in the first position, and where the first side and second side are perpendicular to a vertical axis of the exhaust gas recirculation line in the second position, wherein the central axis and vertical axis are perpendicular to one another.

18. An engine intake system comprising:
a throttle valve having a front side and a backside, where at least the backside includes an insulating element thermally isolating the backside from the front side, the throttle valve being arranged at a junction between an intake passage and a low-pressure exhaust gas recirculation passage between a compressor and the intake passage;
a mounting arranged along a wall of the junction between the intake passage and the low-pressure exhaust gas recirculation passage, wherein the mounting comprises an actuator configured to pivot the throttle valve between a first position, a second position, and a plurality of positions therebetween; and
a controller with computer-readable instructions that when executed enable the controller to:
pivot the throttle valve toward the first position when less intake air is desired and pivot the throttle valve toward the second position when more intake air is desired.

19. The engine intake system of claim 18, wherein the first position includes blocking intake air flow from the intake passage to the compressor via the front side, and where the second position includes blocking low-pressure exhaust gas recirculate flow via the backside.

20. The engine intake system of claim 18, wherein the front side does not thermally communicate with the backside.
